(19) United States
(12) Patent Application Publication
(10) Pub. No.: US 2025/0355738 A1
(43) Pub. Date: Nov. 20, 2025

(54) EDGE DEVICE-BASED SERVICE PROVIDING METHOD USING CODE STREAMING, AND SYSTEM THEREOF

(71) Applicant: Alyce Healthcare Inc., Ulsan (KR)

(72) Inventor: Da Kyum KANG, Ulsan (KR)

(21) Appl. No.: 19/283,798

(22) Filed: Jul. 29, 2025

Related U.S. Application Data
(63) Continuation of application No. PCT/KR2023/008462, filed on Jun. 19, 2023.

(30) Foreign Application Priority Data
Jun. 16, 2023 (KR) 10-2023-0077777

(51) Int. Cl. G06F 9/54

(52) U.S. Cl. CPC G06F 9/547; G06F 9/543

(57) ABSTRACT

Disclosed is a method for providing a service using code streaming, which is performed by an edge-device-based service providing system. The method may include: identifying a motion recognition code module for providing a first service to a user based on a user's selection for the first service; recognizing a motion of the user by executing the identified motion recognition code module based on a motion image of the user which is input to a camera of the service providing system; requesting a service code module which is computed in a code execution device of the service providing system to a service providing server to provide the first service; generating real-time service data for the first service based on the recognized user's motion as the service code module is streamed to be received; and outputting the generated service data through a service output device of the service providing system.

### CROSS-REFERENCE TO RELATED APPLICATIONS

This application is claiming priority from International Application No. PCT/KR2023/008462, filed on Jun. 19, 2023, which claims priority from Korean Patent application No. 10-2023-0077777, filed on Jun. 16, 2023, the entire contents of which are hereby incorporated by reference.

### TECHNICAL FIELD

The present disclosure relates to a method for providing an edge device-based service, and more particularly, to a service providing method of an edge device-based service providing system using code streaming.

### BACKGROUND ART

Various services are being provided through an edge device. To this end, generally, all the specific service-related applications are stored in an internal memory of an edge device as codes and the edge device drives the application by executing the code through a processor to provide the service.

However, the edge device has a relatively very small resource as compared with a cloud computing server so that it is restricted to extend the provided service. Further, when the provided service is demanded to be modified, there is inconvenience of loading a code in the edge device again after changing the code. In order to overcome this problem, when there is a plurality of service accesses, a method of transferring the service to an edge computing environment which is more advantageous for providing the service and operating a resource has been proposed.

However, the proposed service transfer method is also effective in a situation in which the resource is consistently extendable so that in a situation in which the edge device's resource extension is not possible, a solution for a fundamental problem of storing all the related codes for providing the service is not proposed.

### SUMMARY

### Technical Problem

A technical object to be achieved by the present disclosure to solve the above-mentioned problems is to provide a method for streaming and receiving a necessary code in association with service provision without storing all the codes in an edge device and a system thereof.

Specifically, a technical object to be achieved by the present disclosure is to provide a method for determining whether to provide a service based on an existing code loaded in an edge device or whether to provide a service by coupling a code streamed from a service providing server, depending on a requested service specification, such as a type of service selected by a user or a level of service to be provided, and a system thereof.

Another technical object to be achieved by the present disclosure is to provide a method for combining a streamed code module to some code modules, among the existing codes, and a system thereof.

Specifically, another technical object to be achieved by the present disclosure is to provide a method for providing a service by executing a code module provided based on the streaming in real time and a system thereof.

Still another object to be achieved by the present disclosure is to provide a system to which an extended hardware module to execute a streamed code module is applied in addition to the loaded code.

Technical objects of the present disclosure are not limited to the aforementioned technical objects and other technical objects which are not mentioned will be apparently appreciated by those skilled in the art from the following description.

### Technical Solution

In order to achieve the above-mentioned object, according to an exemplary embodiment of the present disclosure, a method for providing a service using code streaming, which is performed by an edge device-based service providing system may include a step of identifying a motion recognition code module for providing a first service to a user based on a user's selection for the first service; a step of recognizing a motion of the user by executing the identified motion recognition code module based on a motion image of the user which is input to a camera of the service providing system; a step of requesting a service code module which is computed in a code execution device of the service providing system to a service providing server to provide the first service; a step of generating real-time service data for the first service based on the recognized user's motion as the service code module is streamed to be received; and a step of outputting the generated service data through a service output device of the service providing system.

In one exemplary embodiment, the step of requesting a service code module to provide the first service may include: a step of determining whether there is a basic code module which is stored in advance in the service providing system and matches the first service; and a step of generating first service data for providing the first service by executing the basic code module if there is a basic code module.

In one exemplary embodiment, the step of generating real-time service data may include: a step of streaming and receiving the service code module and executing the received service code module to generate second service data for the first service; and a step of generating real-time service data, based on the first service data and the second service data.

In one exemplary embodiment, the streamed service code module may include an application programming interface (API) for communicating with the identified motion recognition code module and the step of generating real-time service data may include: a step of generating the real-time service data, by executing the service code module, based on the recognized user's motion for the first service through the API.

In one exemplary embodiment, the step of identifying the motion recognition code module may include: a step of determining whether the identified motion recognition code module satisfies a recognition level for providing the first service; a step of requesting an additional code module of the motion recognition code module for providing the first service, to the service providing server, if the identified motion recognition code module does not satisfy the recognition level as the result of determination; and a step of linking and executing the motion recognition code module and the additional code module as the additional code module is streamed to be received, and the step of recognizing the motion of the user may include: a step of recognizing the motion of the user as the motion recognition module and the additional code module are linked to be executed.

In one exemplary embodiment, the additional code module may include a first API for communicating with the identified motion recognition code module and the step of linking and executing may include: a step of executing the motion recognition code module and the additional code module in response to the input user's motion image while communicating with each other.

In one exemplary embodiment, the additional code module may include a second API for communicating with the streamed service code module and the step of generating real-time service data may include: a step of transmitting the user's motion to the streamed service code module through the second API; a step of analyzing the transmitted user's motion by executing the streamed service code module; and a step of generating the real-time service data for the first service based on the analyzed result.

In one exemplary embodiment, a step of allowing the code execution device to identify that at least one arithmetic device is added by a hardware extension part of the service providing system, and the step of linking and executing the motion recognition code module and the additional code module may include: a step of executing the motion recognition code module through the code execution device; and a step of executing the additional code module based on the first API using the at least one added arithmetic device.

In one exemplary embodiment, the at least one arithmetic device may include a first arithmetic device and a second arithmetic device, the step of executing the additional code module based on the first API using the at least one added arithmetic device may include: a step of executing the additional code module using the first arithmetic device, and the step of generating real-time service data for the first service may include: a step of executing the streamed service code module using the second arithmetic device.

In one exemplary embodiment, the step of outputting the generated service data may include: a step of identifying a user interface (UI) output code module for outputting the generated service data; a step of determining whether the identified UI output code module satisfies an output level for providing the first service; a step of requesting an additional code module of the UI output code module for providing the first service, to the service providing server, if the identified UI output code module does not satisfy the output level as the result of determination; a step of linking and executing the UI output code module and the additional code module as the additional code module is streamed to be received; and a step of outputting the service data generated for the first service by linking and executing the additional code module and the UI output code module.

In one exemplary embodiment, the method may further include: a step of receiving a user's selection for a second service; a step of identifying a motion recognition code module for providing the second service to the user; a step of recognizing the user's motion for providing the second service, by executing the identified motion recognition code module based on the user's image input to the camera; a step of requesting a service code module for providing the second service to the service providing server; a step of removing the streamed service code module for providing the first service as a service code module for providing the second service is streamed to be received; a step of generating real-time service data for the second service based on the recognized user's motion; and a step of outputting service data generated for the second service through a service output device of the service providing system.

In one exemplary embodiment, the step of identifying a motion recognition code module for providing the second service may include: a step of determining whether the additional code module satisfies a recognition level for providing the second service if there is an additional code module received for providing the first service, in addition to the motion recognition code module; and a step of determining whether to delete the additional code module depending on whether the additional code module satisfies a recognition level for providing the second service as the result of determination.

In one exemplary embodiment, the step of determining whether the identified motion recognition code module satisfies a recognition level for providing the first service may include: a step of receiving an update message of the first service from the service providing server; and a step of determining whether to satisfy the recognition level based on the received update message, and the step of receiving a update message of the first service may include: a step of generating a request message for the updated service code module in response to the update message, and the step of requesting the additional code module may include: a step of transmitting a request message for the generated updated service code module to the service providing server together with the request message for the additional code module.

In one exemplary embodiment, a step of allowing the code execution device to identify that an arithmetic device is added by a hardware extension part of the service providing system and a step of executing at least one of the additional code module and the updated service code module in the added arithmetic device as the additional code module and the updated service code module are streamed.

In order to achieve the above-described objects, according to an aspect of the present disclosure, a code streaming system may include: a service providing server which stores at least one service code module; and a service providing system which requests code streaming for a service selected by a user to the service providing server and executes the service code module as a service code module for the selected service is streamed from the service providing server in response to the request, and in which the service providing system may include: a camera to which a user's motion image is input; a code execution device which executes a motion recognition code module to recognize a user's motion image and executes the service code module based on the recognized motion image to generate service data; and a service output device which executes a UI output code module to output the service data, based on the service data.

In order to achieve the above-described objects, according to an exemplary embodiment of the present disclosure, a hardware extendable edge device-based service providing system may request code streaming for a service selected by a user to a service providing server which stores at least one service code module and execute the service code module as the service code module for the selected service is streamed from the service providing server in response to the request.

In one exemplary embodiment, the service providing system may include: a camera to which a user's motion image is input; a code execution device which executes a motion recognition code module to recognize a user's motion image, executes the service code module based on the recognized motion image to generate service data, and includes a hardware extension part for parallel computation for at least one of the motion recognition code module and the service code module; and a service output device which executes an UI output code module to output the service data, based on the service data.

In one exemplary embodiment, the code execution device includes a controller which stores the motion recognition code module in advance and identifies the stored motion recognition code module, the streamed service code module includes an application programming interface (API) for communicating with the identified motion recognition code module and the controller executes the service code module based on the recognized user's motion image for the selected service through the API to generate the service data.

In an exemplary embodiment, as it is identified that at least one arithmetic device is added to the hardware extension part, the controller may execute any one of the motion recognition code module and the streamed service code module, and control the remaining code module other than the any one code module, to be executed through the arithmetic device.

In one exemplary embodiment, when at least one of a recognition level of the motion recognition code module and an output level of the UI output code module does not satisfy a request level of the selected service, the controller may request an additional module to the service providing server.

In one exemplary embodiment, the additional module may include an API for communicating with at least one module of the previously stored motion recognition code module and the UI output code module and when the requested additional module is streamed from the service providing server, the controller may link and execute the at least one module and the additional module through the API so as to satisfy the requested level of the selected service.

In one exemplary embodiment, the controller may execute the at least one module and the service code module. As it is identified that at least one arithmetic device is added to the hardware extension part, the controller may execute some modules, among at least one module, the motion recognition code module, the service code module, and the UI output code module, and control the remaining code module other than the some modules to be executed through the arithmetic device.

### Advantageous Effects

According to an exemplary embodiment of the present disclosure, a service code is streamed to be provided so that there is an advantage in that the service can be provided as long as only a service call code is inserted into an internal memory of the edge device. By doing this, it is possible to receive various services in real time free from the restriction on the internal memory size of the edge memory.

According to an exemplary embodiment of the present disclosure, if there is a matter to be modified in the service, there is no need to replace a service call code of the edge device, but the service code is replaced in a service providing server and the replaced code is streamed to be applied to all edge devices. By doing this, inconvenience of the related art of building a code for modification of the service and loading a newly built code for every edge device is eliminated.

Further, a code streaming method according to the exemplary embodiment of the present disclosure is used so that when an API for the service main code is open, a third party's service code other than a service provider is streamed to the edge device through the service providing server, thereby easily providing various services of the third party to the user.

According to another exemplary embodiment of the present disclosure, in an edge device level, a hardware resource is extendable so that it is possible to optimize resource acquisition and computation, minimize delay, and provide the service in real time, as compared with the extension of the resource at a server level.

The effects of the present disclosure are not limited to the effects mentioned above, and other effects which are not mentioned can be clearly understood by those skilled in the art from the following description.

### BRIEF DESCRIPTION OF DRAWINGS

FIG. 1 is an exemplary view of a code streaming system using an edge device according to an exemplary embodiment of the present disclosure.

FIG. 2 is a block diagram of a code execution device according to another embodiment of the present disclosure.

FIG. 3 is an example of performing code streaming on an edge device according to another exemplary embodiment of the present disclosure.

FIG. 3 is a block diagram of a code execution device according to another embodiment of the present disclosure.

FIG. 4 is a flowchart of a service providing method according to still another exemplary embodiment of the present disclosure.

FIGS. 5 and 6 are examples of a code streaming target code module referenced in some exemplary embodiment of the present disclosure.

FIG. 7 is a flowchart of a method for determining a streaming target based on a necessary resource for every selected service, referenced in still another exemplary embodiment of the present disclosure.

FIG. 8 is an example of an exemplary embodiment of changing a code unit to be streamed for every type of a specific service, referenced in some exemplary embodiment of the present disclosure.

FIG. 9 is an example of an extendable hardware module for executing a streamed code module, referenced in still another exemplary embodiment of the present disclosure.

### DETAILED DESCRIPTIONS OF EXEMPLARY EMBODIMENTS

Hereinafter, exemplary embodiments of the present disclosure will be described in detail with reference to the accompanying drawings. Advantages and features of the present disclosure, and methods for accomplishing the same will be more clearly understood from exemplary embodiments described below with reference to the accompanying drawings.

However, the present disclosure is not limited to the following exemplary embodiments but may be implemented in various different forms. The exemplary embodiments are provided only to complete disclosure of the present disclosure and to fully provide a person having ordinary skill in the art to which the present disclosure pertains with the category of the disclosure, and the present disclosure will be defined by the appended claims. Like reference numerals generally denote like elements throughout the specification.

Unless otherwise defined, all terms (including technical and scientific terms) used in the present specification may be used as the meaning which may be commonly understood by the person with ordinary skill in the art, to which the present disclosure belongs. It will be further understood that terms defined in commonly used dictionaries should not be interpreted in an idealized or excessive sense unless expressly and specifically defined. The terms used in the present specification are for explaining the exemplary embodiments rather than limiting the present disclosure. Unless particularly stated otherwise in the present specification, a singular form also includes a plural form.

Hereinafter, in the present specification, an edge device-based service providing system using code streaming may be simply referred to as a service providing system or a system.

In the present specification, the terms, such as “module”, “unit”, and “part” are units of software and/or hardware and for example, a code module may refer to a bundle of codes which perform a specific function related to a service selected by a user of the present disclosure.

The hardware module may be, for example, a hardware resource existing as a process-specific unit to perform a computation of the service-related specific function.

The module may not only exist as a software module or a hardware module, but also may refer to a unit in which specific software and hardware are combined.

Hereinafter, the service according to the exemplary embodiment of the present disclosure may be a training service which performs artificial intelligence-based skeleton analysis on a user's motion in real time to guide a motion of the user in accordance with an exercise type which is selected by a user or programmed and analyzes and evaluates a real-time user's motion, and for example, may be a home workout service including personal training (PT), Cross-Fit, Yoga, Pilates, gymnastics, dance, mediation, and the like.

Further, the service may manage an exercise course, an exercise volume and/or mental and physical relaxation by analyzing and evaluating the user's motion, but is not limited to the above-described type.

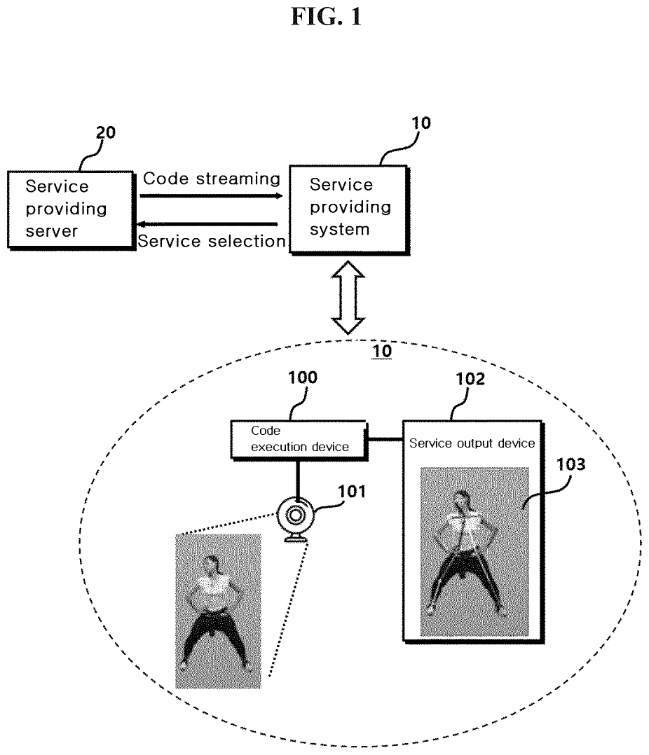

FIG. 1 is an exemplary view of a code streaming system using an edge device according to an exemplary embodiment of the present disclosure.

Referring to FIG. 1, a code streaming system includes a service providing system 10 and a service providing server 20.

The service providing system 10 and the service providing server 20 are computing devices which perform data communication with each other. According to the exemplary embodiment of the present disclosure, the service providing system 10 may provide user's service selection information to the service providing server 20 and request a service code module. The service providing server 20 may stream the code module in response to the request of the service providing system 10.

Even though in FIG. 1, the service providing system 10 and the service providing server 20 are represented as separate components, according to another exemplary embodiment of the present disclosure, the service providing system 10 may include a service providing server 20.

The service providing system 10 may include at least one edge device. For example, the service providing system 10 may include a code execution device 100, a camera 101, and a service output device 102. Even though it is not illustrated in the drawing, the service providing system 10 may further include an IoT exercise device and also include a sound device.

The components of the service providing system 10 may communicate with each other through a wired/wireless network. Specifically, the code execution device 100 is an embedded edge device which provides a service according to the exemplary embodiment of the present disclosure and may totally control the function and the operation of the component of the service providing system 10.

Further, the components of the service providing system 10 are separately illustrated, but may be configured as one integrated device.

When a user selects a service, the code execution device 100 may identify a motion recognition code module which is stored in advance to provide a selected service based on the user's selection.

For example, a selectable service type may be any one of P.T., Yoga, rehabilitation exercise, diet exercise, and a dance training and the service selection may include selection on not only a type of the service, but also a course or a level (high, intermediate, or low level) of each service.

The motion recognition code module is executed by the code execution device 100 to identify a motion of the user and specifically, identify the user's motion based on a content of the selected service.

That is, according to the exemplary embodiment, the code execution device 100 may identify and execute different motion recognition code modules according to the selected service.

According to another exemplary embodiment, the code execution device 100 may omit execution of at least some codes of the motion recognition code module according to the selected service.

The above-described service content may include a motion guide display, a motion tracking score, exercise volume information, course achievement information, a sound, graphic effects, and the like which are differently applied according to a type, a course, and a level of the selected service.

For example, in the case of the rehabilitation motion, identification of a motion accuracy of a three-dimensional image may be important and in the case of the dance training, an identification speed of the motion may be important. In the case of the diet program, the measurement of exercise volume may be a priority. That is, depending on the selected service, a requirement for an analysis result obtained by executing a motion recognition code module may vary.

When a motion image of the user is input to the camera 101, the code execution device 100 executes the identified motion recognition code module based on the selected service to recognize the motion of the user.

For example, as illustrated in FIG. 1, the code execution device 100 may recognize the motion of the user through the artificial intelligence-based skeleton analysis.

The code execution device 100 executes the service code module based on the user's motion recognized as described above to generate a service content.

Even though it is not illustrated, the service content may include a motion of a tutor to guide a motion in accordance with a type, a course, and a level of the service to the user. The tutor's motion may be displayed in a first area of the service output device 102 according to a service setting. The tutor may be a virtual character or a trainer who actually teaches the service.

For example, when the service type is dance training, the user may watch the tutor's motion displayed in the first area to take dance motions in real time and the dance motion of the user may be input through the camera 101 to be displayed in a second area of the service output device 102.

At this time, as the motion code module is executed by the code execution device 100, the skeleton analysis is performed on the user's dance motion and as the service code module is executed, the dance motion is combined with the dance training content to be displayed.

The service output device 102 may simultaneously display a content including the tutor's dance motion and the user's dance motion in the first area and the second area, respectively, and display combined dance training contents.

According to the exemplary embodiment of the present disclosure, in order to provide the service selected by the user, the code execution device 100 may request the service code module to be computed to the service providing server 20. That is, the code execution device 100 is an edge device and may receive the corresponding service code module which is streamed in real time from the service providing server 20 based on the type, the course and/or the level of the selected service, without storing all the codes, due to the limitation of the storage capacity.

As the service code module is streamed to be received, the code execution device 100 may generate real-time service data for the selected service based on the recognized user's motion.

The code execution device 100 may output the generated service data through the service output device 102 and in FIG. 1, a service data screen 103 of the service output device 102 is illustrated. The service data may be data in which the recognized user motion and the above-described service content are combined.

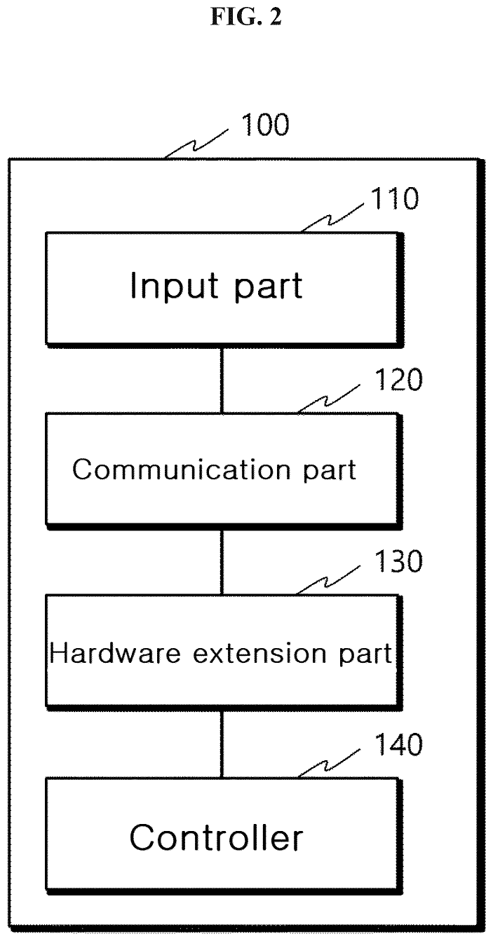

FIG. 2 is a block diagram of a code execution device 100 according to another embodiment of the present disclosure.

According to the exemplary embodiment, the code execution device 100 may include an input part 110, a communication part 120, a hardware extension part 130, and a controller 140.

For example, the input part 110 may include at least one of various types of devices which allow a user to input data to the code execution device 100, such as a keyboard, a mouse, a touch screen, and an exclusive remote controller.

In one exemplary embodiment, the user uses the input part 110 to select a service type, a service course, a service level and/or an IoT device used for the service.

The communication part 120 supports wired/wireless communication between the code execution device 100 and the camera 101, the service output device 102 and/or the service providing server 20. For example, the communication part 120 may support various communication methods, such as short-distance communication and wired connection in addition to the Internet, which is a public communication network. To this end, the communication part 120 may include at least one of a communication module and a connection terminal which are well-known in the technical field of the present disclosure.

The hardware extension part 130 may provide an interface which attaches or detaches one or more arithmetic devices including a processor and distribute an arithmetic capacity of the code execution device 100.

For example, the arithmetic device may operate as a computer. For example, when one arithmetic device is mounted in the hardware extension part 130, all the code modules may be executed in one arithmetic device.

As another example, even in the code module for executing one function, for example, even in a motion recognition code module, some codes may be processed in the code execution device and the other code may be executed in the arithmetic device.

In contrast, when two or more arithmetic devices are mounted in the hardware extension part 130, one code module may be distributed-parallel processed in two arithmetic devices.

Further, as still another example, when two or more arithmetic devices are mounted in the hardware extension part 130, one of a plurality of code modules has an execution path designated to the first arithmetic device to be executed in a first arithmetic device and the other code module may be executed in a second arithmetic device.

According to the exemplary embodiment, the arithmetic device may be at least one of a general-purpose arithmetic device including a general-purpose processor and an exclusive arithmetic device including a specific software arithmetic processor.

For example, the general-purpose arithmetic device may have the same performance as an edge device hardware used for the existing IoT device which uses the processor. The general-purpose arithmetic device may execute all types of software which are executed in the code execution device 100.

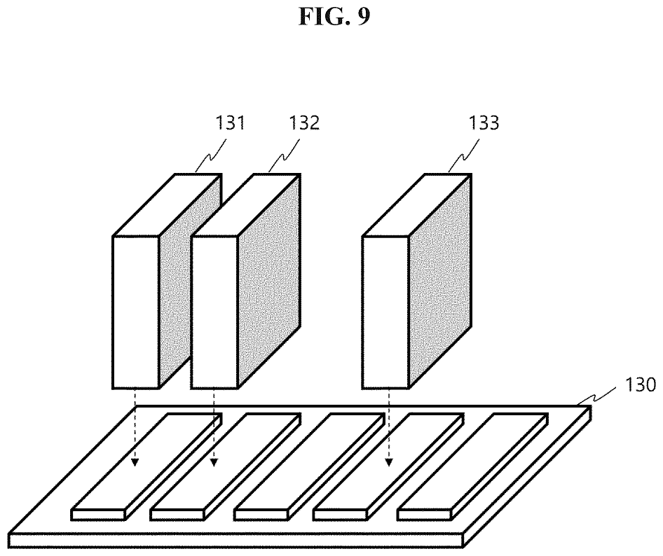

For example, the exclusive arithmetic device loads FPGA-based hardware accelerator to increase an arithmetic processing speed. The exclusive arithmetic device may execute only a specified specific code module. Additionally, a specific code module which may be executed in the exclusive arithmetic device may be executed in at least one of a general-purpose arithmetic device and an exclusive arithmetic device. To this end, the controller 140 may control the execution of the specific code module. The hardware extension part 130 will be additionally described below in the description of FIG. 9.

The controller 140 controls an overall operation of each configuration of the code execution device 100 and the service providing system 10. To this end, the controller 140 may be configured to include one or more processors and for example, may be configured to include at least one of a central processing unit (CPU), a microprocessor unit (MPU), a micro controller unit (MCU), an application processor (AP), or an arbitrary type of processor which is well known in the technical field of the present disclosure.

The controller 140 may perform computation for at least one application or program to execute the method according to the exemplary embodiments of the present disclosure. Even though it is not illustrated in the drawings, the controller 140 may include a memory and a storage and software stored in the storage is loaded on the memory to be computed.

According to the exemplary embodiment, the controller 140 may receive a user motion image from the camera. For example, the user motion image may be an image obtained by capturing a body motion of a user for health care or exercise coaching.

According to the exemplary embodiment, the controller 140 executes a predetermined code module in a processor installed in at least one arithmetic device, among one or more arithmetic devices which are attached to the hardware extension part 130 to generate analysis data for the user motion image. At this time, the analysis data may be data obtained by analyzing a body pose, a motion, and a balance of the captured user and may be skeleton analysis data as described above.

According to the exemplary embodiment, the controller 140 may provide setting UI for a type, a course, a level, and a difficulty of the service from the user through the service output device 120 and receive execution request data which request execution of the related code module through the input part 110.

According to the exemplary embodiment, the controller 140 may request predetermined software for providing a service to the service providing server 20 through the communication part 120. For example, the code execution device 100 may store a specific type of software in its own memory (not illustrated). However, specific software, such as software having a large capacity or software which is not frequently used, is not stored in the memory, but is received from the service providing server 20 as it is needed, to be executed.

According to the exemplary embodiment, the code execution device 100 may store a code module, such as a motion recognition code module or an UI output code module and when a service selection input is received from the user, simultaneously receives and executes the service code module which is streamed from the service providing service 20 to generate the service data.

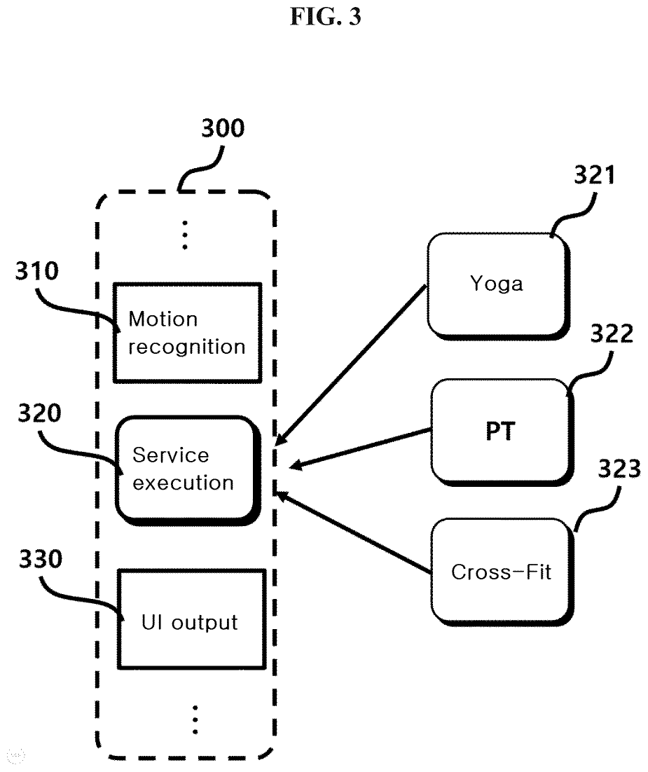

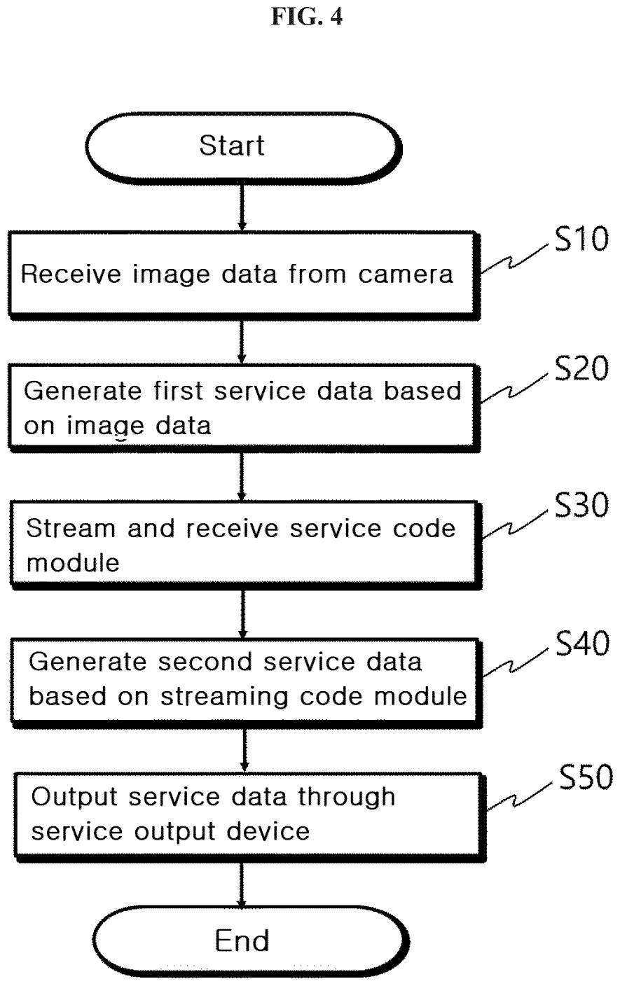

FIG. 3 is an example of performing code streaming on an edge device according to another exemplary embodiment of the present disclosure. Referring to FIG. 3, the code execution device 100 may execute software 300 for providing a service.

The software 300 may be configured to include a plurality of code modules in the functional units. In FIG. 3, an example including a motion recognition code module 310 for a motion recognition function, a service execution code module 320 for providing a service, and a UI output code module 330 for outputting service data including service content is illustrated. Hereinafter, the service execution code module 320 may be referred to as a service code module.

As described above, the code execution device 100 stores a predetermined code module in the memory, but it may receive and execute the specific code module from the service providing server 20 as it is needed.

For example, the code execution device 100 stores the motion recognition code module 310 and the UI output code module 330 in the memory, but it may receive and execute the service execution code module 320 which is streamed when it is requested to provide the selected service as the user selects the service.

For example, when the user selects any one of the services, Yoga 321, P.T. 322, and Cross-Fit 323, the execution code module for the selected service may be streamed. Accordingly, the code execution device 100 executes the motion recognition code module 310 in real time to analyze a user motion image, and based on the analysis results, it simultaneously receives and executes the streamed service execution code module 320 to generate the service data.

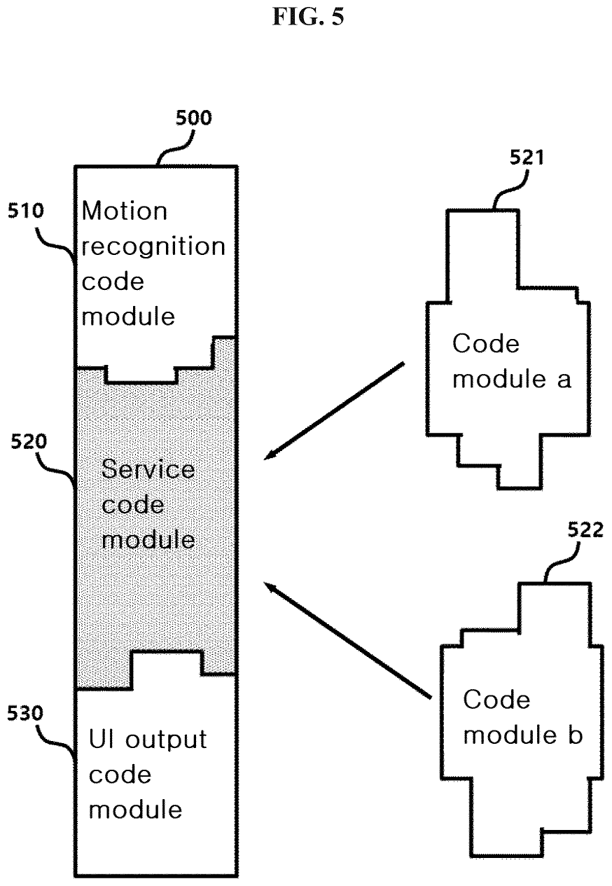

FIG. 4 is a flowchart of a service providing method according to still another exemplary embodiment of the present disclosure.

Each step of FIG. 4 is performed by the service providing system 10 and specifically, may be performed by components of the service providing system 10. Specifically, various code modules to be described below are computed by the controller 140 of the code execution device 100 to be executed.

Referring to FIG. 4, the code execution device 100 receives image data from the camera 101 in step S10. The image data is a motion image of the user and as described above, as the motion recognition code module is executed in the code execution device 100, the motion image of the user is analyzed.

The analysis for the motion image of the user may be artificial intelligence-based skeleton analysis.

In one exemplary embodiment, as the user's motion image is received, the code execution device 100 may request streaming of the service code module to the service providing server.

In another exemplary embodiment, when a service code module matching a service selected by the user is stored in the internal memory of the code execution device 100, the code execution device 100 executes the service code module stored in the internal memory to generate service data based on the skeleton analysis.

The code execution device 100 may determine whether the service code module stored in the internal memory is sufficient to execute the service selected by the user. Specifically, the service code module matches a service information table including at least one of a service type, such as Yoga or dance, a difficulty, a service course, a level, an output setting of the service, and an exercise volume to be stored in the service providing server. The code execution device 100 identifies a matching value of the service information table by scanning the service code module stored in the memory to determine what type of exercise the service course module is related to and what type of course, level, and exercise volume and output setting the code module corresponds to.

An arithmetic volume of the code execution device 100 varies according to a service type, a course type, a level, and an output setting.

For example, when the service selected by the user is dance training which requires continuous motions within a short time, the code execution device 100 may perform rapid analysis on the continuous motions by executing the motion recognition code module. The code execution device 100 executes the service code module to process a plurality of events matching an analysis result for the continuous motions to generate service data.

To this end, the service code module makes calls and responses with the motion recognition code module and/or the UI output code module for each of the plurality of events.

At this time, when an output setting of the user for the service selected by the user is a high level, for example, when the user motion needs to be sensitively analyzed and a requested level of the graphic effect of the UI output is set to be high, the code execution device 100 may determine that the service code module stored in the internal memory is not sufficient. In this case, all the motion recognition code module, the service code module, and the UI output code module may be configured by codes corresponding to a service whose output is set to a high level.

Accordingly, in order to satisfy the high level of output setting, the code execution device 100 requests the streaming of the matching service code module to the service providing server.

Further, in still another example, when the user output setting for the service selected by the user is a low level, for example, when a requested level for at least one of the sensitive analysis for the user's motion and the requested level of the graphical effect of the UI output is low, the code execution device 100 may determine that the service code module stored in the internal memory is sufficient.

At this time, even though the motion recognition code module is configured by a code which is capable of responding to the high level of output settings which allow the sensitive analysis on the user motion, when the service code module and/or the UI output code module is executed, the code execution device 100 may omit a respond for at least some instructions called from the motion recognition code module in response to the low level of output setting.

In this case, the code execution device 100 does not need to request the service code module to respond to the high level of output setting so that it is determined whether there is a service code module stored in the memory.

According to the exemplary embodiment of the present disclosure, when the stored service code module is a basic code module which is commonly used regardless of the service type, the code execution device 100 determines that there is a basic code module and executes the basic code module to generate service data in step S20.

That is, when the service code module responding to the high level of output setting is not necessary, the code execution device 100 executes the basic code module which has been stored, instead of the service code module streaming request, to generate first service data including an event which needs to be commonly provided through the service selected by the user. The first service data is service data generated by executing the basic code module stored in the memory by the code execution device 100.

However, when the service data which is generated by executing only the basic code module does not match the service selected by the user and/or the output setting, even though the basic code module is stored, the code execution device 100 requests the service code module to receive the streamed service code module in step S30.

The code execution device 100 executes the received service code module to generate second service data for the service selected by the user in step S40. The second service data is service data generated by executing the streamed service code module received by the code execution device 100.

The code execution device 100 may generate real-time service data based on the first service data and the second service data in step S50.

According to the exemplary embodiment of the present disclosure, the code execution device 100 may execute the motion recognition code module, the service code module, and the UI output code module sequentially or in parallel, or execute at least some codes sequentially and execute the other codes in parallel.

To this end, the motion recognition code module, the service code module, and the UI output code module communicate with each other through an application programming interface (API) and exchange requests and responses therebetween. Further, the motion recognition code module, the service code module, and the UI output code module may also be internally configured by a plurality of code module groups.

For example, the service code module is a code which is functionally executed by the code execution device 100 to generate service data, but is internally configured by the basic code module and the streamed service code module to communicate with each other through the API and generate the service data.

As another example, the motion recognition code module and the UI output code module may also be internally configured by a combination of the plurality of code module groups.

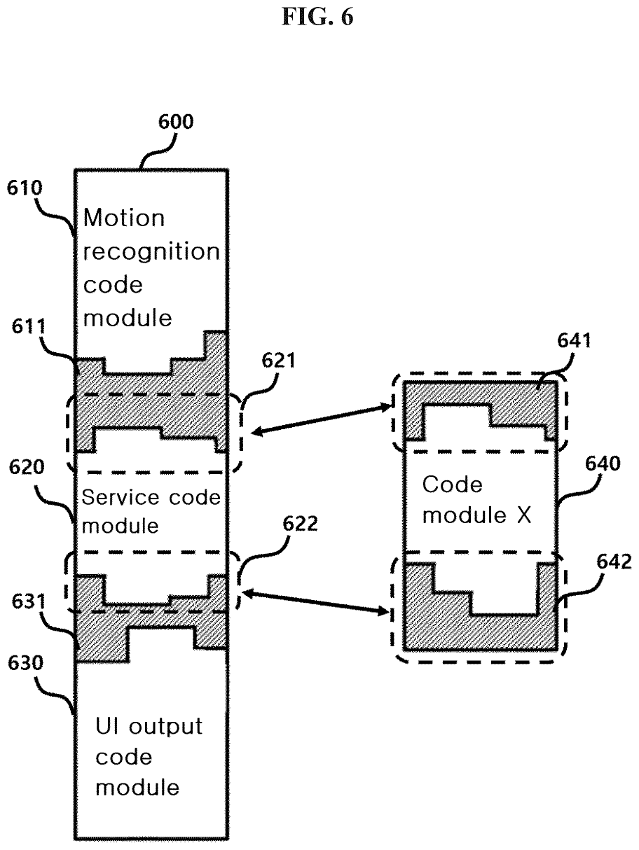

FIGS. 5 and 6 are examples of a code streaming target code module referenced in some exemplary embodiment of the present disclosure. Specifically, in FIGS. 5 and 6, for the convenience of description, the software code is represented as a physical structure.

Specifically, each code module is illustrated as a block and in FIG. 5, each code module is represented by a structure which includes a convex portion and a groove in which the convex portion is seated to be coupled to each other.

In FIGS. 5 and 6, the code module is represented as a structurized block for the convenience of description, but may actually be bundles of software codes.

Each code module includes an application programming interface (API) to communicate with each other and in FIGS. 5 and 6, the communication between the APIs included in the code modules is represented by the coupling or bonding between the code module block and another code module block.

Referring to FIG. 5, the code execution device 100 may execute a code 500 to provide the service. The code 500 may include a motion recognition code module 510, a service code module 520, and the UI output code module 530.

It is assumed that the motion recognition code module 510 and the UI output code module 530 are code modules which are applied to various services for general purpose, but service code modules to execute a service are different for every service.

As the service code module 520 of the code execution device 100 is executed, the service providing system 10 may provide a predetermined service to the user.

At this time, when the user selects a new service or changes a level of the output setting, a code other than the code 500 needs to be executed.

The other code 500 may be a code in which at least one of the motion recognition code module 510, the service code module 520, and the UI output code module 530 which configure the code 500 is changed.

When the service selected by the user is changed, to this end, the motion recognition code module 510 and the UI output code module 530 are executed as it is, but a code module a 521 or a code module b 522 needs to be executed, rather than the service code module 520.

However, referring to FIG. 5, the code module a 521 or the code module b 522 may not be applied to the code 500 due to the structure. Specifically, a shape of a lower end of the motion recognition code module 510 and a shape of an upper end of the code module a 521 or the code module b 522 cannot be coupled. Further, a shape of an upper end of the UI output code module and a shape of a lower end of the code module a 521 or the code module b 522 cannot be coupled.

It means that in the code 500, the code module a 521 or the code module b 522 does not include the API for communicating with the motion recognition code module 510 and the UI output code module 530, instead of the service code module 520.

Accordingly, it is not possible to replace the service code module 520 of the code 500 with any one of the code module a 521 or the code module b 522 and the code execution device 100 needs to download all the codes corresponding to the other service from the service providing server 20 and store the codes in the memory, for a service other than the service corresponding to the code 500.

That is, when the code for the service has a structure as illustrated in FIG. 5, in situations of changing a service type, modifying and updating a service, all edge devices connected to the service providing server need to download new codes, respectively.

In FIG. 6, a code 600 according to an exemplary embodiment of the present disclosure is proposed to solve the structural problem of the code 500 of FIG. 5. In FIG. 6, for the convenience of description, the coupling structure is illustrated such that each of the code modules is configured as a flat cross-section to be bonded to each other.

Referring to FIG. 6, a code 600 includes a motion recognition code module 610, a service code module 620, and a UI output code module 630.

As compared with the code 500 of FIG. 5, the cross-sections of the motion recognition code module 610, the service code module 620, and the UI output code module of the code 600 are represented to be flat.

For example, the motion recognition code module 610 includes an API 611 to communicate with the service code module through an API 621 and the service code module 620 includes an API 622 to communicate with the UI output code module 630 through an API 631.

The service code module 620 includes an API for communication with a coupler 621 of the motion recognition code module 610 and includes a coupler 621 and a coupler 622 to be coupled with the coupler 611 and a coupler 631.

The code execution device 100 executes the code 600 such that the service code module 620 is executed based on a motion of a user recognized for the selected service through the APIs 611 and 621 of the motion recognition code module 610 to generate real-time service data.

After executing the code 600, when the user selects a new service or changes a level of output setting, the code execution device 100 needs to execute a code other than the code 600. Referring to FIG. 6, the service code module 620 on the code 600 may be replaced with a code module X 640. That is, as the code module X 640 is streamed from the service providing service 20 to the service providing system 10, the code module X 640 may be applied to the code 600 stored in the code execution device 100.

To this end, an API 641 is in contact with the API 611, instead of the API 621 part to couple the code module X 640 and the motion recognition code module 610. Further, an API 642 is in contact with the API 631, instead of the API 622 part to couple the code module X 640 and the UI output code module 630.

As a user motion recognition result of the motion recognition code module 610 is transmitted to the code module X 640 through the API 611 and the API 641 and the code execution device 100 executes the streamed code module X 640, the service providing system 10 may analyze the transmitted user's motion and generate real-time service data for the selected service based thereon.

That is, according to the exemplary embodiment of the present disclosure, the API of the code 600 is open so that the service code module may be developed by various service developers to be interlinked with the code 600. Accordingly, various service code modules including an API which is applicable to the code 600 communicate with the motion recognition code module 610 and/or the UI output code module 630 to provide various services.

According to the exemplary embodiment of the present disclosure, when a third party's service code module is uploaded, the service providing system 10 and/or the service providing server 20 may scan the uploaded service code module.

Based on a scanning result, the service providing system 10 and/or the service providing server 20 may determine whether the uploaded service code module is communicable with a previously stored code to provide a service according to the exemplary embodiment of the present disclosure through an API of the uploaded service code module.

If it is not possible to communicate between the previously stored code and the uploaded service code module, the service providing system 10 and/or the service providing server 20 may delete the uploaded service code module.

In the above description, the exemplary embodiment that the service code module is replaced on the code has been mainly described, but the exemplary embodiment of the present disclosure is not limited thereto. Hereinafter, an exemplary embodiment that at least a part of the motion recognition code module or the UI output code module is replaced, in addition to the service code module, will be described.

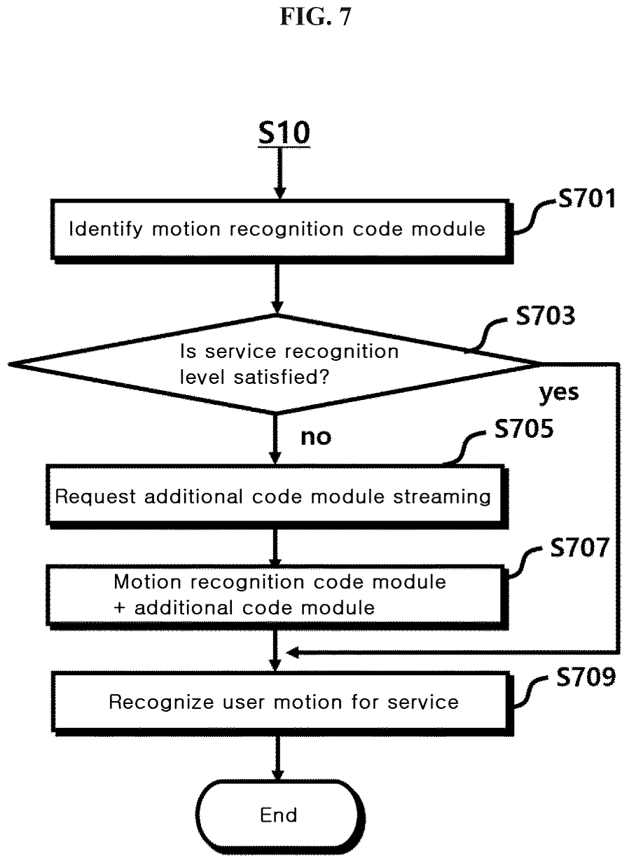

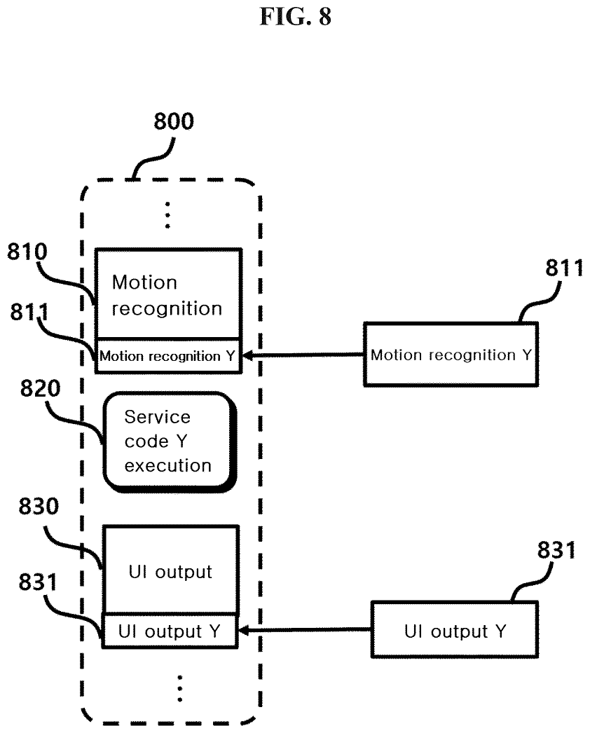

FIG. 7 is a flowchart of a method for determining a streaming target based on a necessary resource for every selected service, referenced in still another exemplary embodiment of the present disclosure. Further, FIG. 8 is an example of an exemplary embodiment of changing a code unit to be streamed for every type of a specific service, referenced in some exemplary embodiments of the present disclosure.

Referring to FIG. 7, when in the step S10 of FIG. 3, image data is received from the camera, the service providing system 10 may identify a motion recognition code module stored in the memory of the code execution device 100 in step S701.

The service providing system 10 may determine whether the motion recognition code module stored in the memory satisfies a recognition level required for the service selected by the user in step S703. For example, the service selected by the user needs to precisely analyze a three-dimensional motion by means of the skeleton analysis so that when the motion recognition code module stored in the memory is for analyzing a two-dimensional motion, the code execution device 100 may determine that a recognition level of the stored motion recognition code module does not satisfy a requested level.

When the identified motion recognition code module does not satisfy the required recognition level, the service providing system 10 may request an additional code module of the motion recognition code module for providing the selected service to the service providing server 20 in step S705.

The relationship of the motion recognition code module and the additional code module is similar to a relationship of the motion recognition module and the service code module and the relationship of the service code module and the UI output code module which communicate with each other through the API described in the description of FIG. 6.

That is, the additional code module is streamed to the code execution device 100 from the service providing server 20 and the motion recognition code module which has been stored in advance may communicate with the additional code module through an interlocking API in step S707.

According to the exemplary embodiment, the code execution device 100 may link and execute the motion recognition code module and the additional code module.

In another exemplary embodiment, a code module which satisfies a recognition level for providing a service selected by the user may be generated by the communication between the motion recognition code module and the additional module through the API.

The code execution device 100 executes a code module which satisfies the recognition level to recognize the user motion in step S709.

The above-described exemplary embodiment of FIG. 7 may also be applied to the UI output code module, in addition to the motion recognition code module.

In the step S50 of FIG. 4, the code execution device 100 may identify a UI output code module for outputting the generated service data.

The code execution device 100 may determine whether the identified UI output code module satisfies an output level for providing the service selected by the user. As a result of determination, if the identified UI output code module does not satisfy the output level, the additional code module of the UI output code module for providing the selected service may be requested to the service providing server 20.

As the code execution device 100 receives the streamed additional code module, the UI output code module and the additional code module are linked to be executed so that service data which satisfies the output level of the selected service may be output.

In FIG. 8, a code 800 includes a motion recognition code module 810 and if the motion recognition code module 810 does not satisfy the recognition level of the selected service, the code execution device 100 may receive the streaming of a motion recognition Y code module 811 which is an additional code module. The motion recognition code module 810 and the motion recognition Y code module 811 may communicate with each other through an API.

By doing this, the user motion recognition which satisfies a service requested specification is made and the code execution device 100 executes a service code module Y 820 to generate service data.

The code execution device 100 executes a UI output code module 830 to output service data. At this time, when the UI output code module 830 does not satisfy the output level of the selected service, the code execution device 100 receives the streaming of a UI output Y code module 831 from the service providing server 20 to output service data.

FIG. 9 is an example of an extendable hardware module for executing a streamed code module, referenced in still another exemplary embodiment of the present disclosure.

In FIG. 9, the hardware extension part 130 is illustrated as a slot structure and an example that arithmetic devices 131, 132, and 133 are inserted into a slot of the hardware extension part 130 is illustrated.

Each of the arithmetic devices 130, 131, and 132 may store software for executing a memory and a code module. In another example, at least some of the arithmetic devices 131, 132, and 133 may include their own processors.

At least one of the arithmetic devices 131, 132, and 133 is inserted into the hardware extension part 130, the code execution device 100 may identify that at least one arithmetic device is added through the hardware extension part 130 of the service providing system.

In one exemplary embodiment, when the motion recognition code module and the additional code module are linked to be executed, the motion recognition code module may be executed by the code execution device 100 and the additional code module may be executed through the API which interlocks with the motion recognition code module using the added arithmetic device 131. The controller 140 may load and compute the motion recognition code module through the internal memory and also load and compute the additional code module through the memory in the arithmetic device. Alternatively, the controller 140 may compute the motion recognition code module and the additional code module may also be computed by a processor in the arithmetic device.

In another example, when the motion recognition code module and the additional code module are linked to be executed, the code execution device 100 may execute the motion recognition code module, execute an additional code module using the added arithmetic device 131, and execute the service code module using the added arithmetic device 132.

According to the exemplary embodiment of the present disclosure, even when the service is updated, the arithmetic devices 131, 132, and 133 may be utilized.

A service code module to be executed by the code execution device 100 may be changed by modifying and/or updating a service content.

The code execution device 100 may receive a service update message from the service providing server 20 and determine whether a recognition level of the motion recognition code module stored in the memory satisfies a requested specification of the updated service.

The code execution device 100 may generate a request message for the updated service code module in response to the service update message.

At this time, the code execution device 100 may transmit a request for the additional code module for the motion recognition code module to the service providing server, together with a request message generated for the updated service code module. This is because when a recognition level of the motion recognition code module is low so that an additional code module is necessary, not only the streaming of the updated service code module, but also the additional code module is necessary.

At this time, when the code execution device 100 identifies that the arithmetic device is added through the hardware extension part of the service providing system 10, the additional code module and the updated service code module are streamed so that the added arithmetic device may execute at least one of the additional code module and the updated service code module.

That is, in at least one of arithmetic devices and the code execution device 100, the additional code module and the updated service code module may be executed in parallel.

In the meantime, according to another exemplary embodiment of the present disclosure, after executing the first service by the code execution device 100, selection for a second service may be input from the user. For example, after doing Yoga exercise as the first service, the user may select dance training as the first service.

The service providing system 10 or the code execution device 100 may identify a motion recognition code module for providing the second service.

When there is an additional code module received for providing the first service, in addition to the motion recognition code module for providing the first service, the service providing system 10 or the code execution device 100 may determine whether the additional code module satisfies a recognition level for providing the second service.

As a result of determination, the service providing system 10 or the code execution device 100 may determine whether to delete the additional code module depending on whether the additional code module satisfies the recognition level for providing the second service.

The service providing system 10 or the code execution device 100 executes the motion recognition code module identified based on an image of the user input to the camera to recognize the motion of the user for providing the second service.

The service providing system 10 may request the service code module for providing the second service from the service providing server 20.

As the service code module for providing the second service is streamed to be received, the code execution device 100 may remove the streamed service code module for providing the first service.

The code execution device 100 may generate real-time service data for the second service based on the recognized user's motion and output the generated service data through the service output device.

The processor and/or methods for determining and/or computing a controller according to the exemplary embodiments of the present disclosure which have been described above with reference to the accompanying drawings so far may be performed by the execution of a computer program embodied in a computer readable code. The computer program is transmitted from the first computing device to the second computing device through a network such as Internet to be installed in the second computing device so that the computer program may be used in the second computing device. The first computing device and the second computing device may include both a fixed computing device such as a server device and a desktop PC and a mobile computing device such as a laptop computer, a smart phone, or a tablet PC.

The exemplary embodiments of the present disclosure have been described with reference to the accompanying drawings, but those skilled in the art will understand that the present disclosure may be implemented in another specific form without changing the technical spirit or an essential feature thereof. Thus, it is to be appreciated that exemplary embodiments described above are intended to be illustrative in every sense, and not restrictive.

1. A method for providing a service using code streaming, which is performed by an edge device-based service providing system, comprising:
a step of identifying a motion recognition code module for providing a first service to a user based on a user's selection for the first service;
a step of recognizing a motion of the user by executing the identified motion recognition code module based on a motion image of the user which is input to a camera of the service providing system;
a step of requesting a service code module which is computed in a code execution device of the service providing system to a service providing server to provide the first service;
a step of generating real-time service data for the first service based on the recognized user's motion as the service code module is streamed to be received; and
a step of outputting the generated service data through a service output device of the service providing system.

2. The method for providing a service using code streaming according to claim 1, wherein the step of requesting a service code module to provide the first service includes:
a step of determining whether there is a basic code module which is stored in advance in the service providing system and matches the first service; and
a step of generating first service data for providing the first service by executing the basic code module if there is the basic code module.

3. The method for providing a service using code streaming according to claim 2, wherein the step of generating real-time service data includes:
a step of streaming and receiving the service code module and executing the received service code module to generate second service data for the first service; and
a step of generating the real-time service data, based on the first service data and the second service data.

4. The method for providing a service using code streaming according to claim 1, wherein the streamed service code module includes an application programming interface (API) for communicating with the identified motion recognition code module and
the step of generating real-time service data includes:
a step of generating the real-time service data, by executing the service code module, based on the recognized user's motion for the first service through the API.

5. The method for providing a service using code streaming according to claim 1, wherein the step of identifying the motion recognition code module includes:
a step of determining whether the identified motion recognition code module satisfies a recognition level for providing the first service;
a step of requesting an additional code module of the motion recognition code module for providing the first service, to the service providing server, if the identified motion recognition code module does not satisfy the recognition level as the result of determination; and
a step of linking and executing the motion recognition code module and the additional code module as the additional code module is streamed to be received, and
the step of recognizing the motion of the user includes:
a step of recognizing the motion of the user as the motion recognition module and the additional code module are linked to be executed.

6. The method for providing a service using code streaming according to claim 5, wherein the additional code module includes a first API for communicating with the identified motion recognition code module and
the step of linking and executing includes:
a step of executing the motion recognition code module and the additional code module while communicating with each other in response to the input user's motion image.

7. The method for providing a service using code streaming according to claim 6, wherein the additional code module includes a second API for communicating with the streamed service code module and
the step of generating real-time service data includes:
a step of transmitting the user's motion to the streamed service code module through the second API;
a step of analyzing the transmitted user's motion by executing the streamed service code module; and
a step of generating the real-time service data for the first service based on the analyzed result.

8. The method for providing a service using code streaming according to claim 6, further comprising:
a step of allowing the code execution device to identify that at least one arithmetic device is added by a hardware extension part of the service providing system,
wherein the step of linking and executing the motion recognition code module and the additional code module includes:
a step of executing the motion recognition code module through the code execution device; and
a step of executing the additional code module based on the first API using the at least one added arithmetic device.

9. The method for providing a service using code streaming according to claim 8, wherein the at least one arithmetic device includes a first arithmetic device and a second arithmetic device,
the step of executing the additional code module based on the first API using the at least one added arithmetic device includes:
a step of executing the additional code module using the first arithmetic device, and
the step of generating real-time service data for the first service includes:
a step of executing the streamed service code module using the second arithmetic device.

10. The method for providing a service using code streaming according to claim 1, wherein the step of outputting the generated service data includes:
a step of identifying a user interface (UI) output code module for outputting the generated service data;
a step of determining whether the identified UI output code module satisfies an output level for providing the first service;
a step of requesting an additional code module of the UI output code module for providing the first service, to the service providing server, if the identified UI output code module does not satisfy the output level as the result of determination;
a step of linking and executing the UI output code module and the additional code module as the additional code module is streamed to be received; and
a step of outputting the service data generated for the first service by linking and executing the additional code module and the UI output code module.

11. The method for providing a service using code streaming according to claim 1, further comprising:
a step of receiving a user's selection for a second service;
a step of identifying a motion recognition code module for providing the second service to the user;
a step of recognizing the user's motion for providing the second service, by executing the identified motion recognition code module based on the user's image input to the camera;
a step of requesting a service code module for providing the second service to the service providing server;
a step of removing the streamed service code module for providing the first service as the service code module for providing the second service is streamed to be received;
a step of generating real-time service data for the second service based on the recognized user's motion; and
a step of outputting the service data generated for the second service through the service output device of the service providing system.

12. The method for providing a service using code streaming according to claim 11, wherein the step of identifying a motion recognition code module for providing the second service includes:
a step of determining whether the additional code module satisfies a recognition level for providing the second service if there is an additional code module received for providing the first service, in addition to the motion recognition code module; and
a step of determining whether to delete the additional code module depending on whether the additional code module satisfies the recognition level for providing the second service as the result of determination.

13. The method for providing a service using code streaming according to claim 5, wherein the step of determining whether the identified motion recognition code module satisfies the recognition level for providing the first service includes:
a step of receiving an update message of the first service from the service providing server; and
a step of determining whether to satisfy the recognition level based on the received update message, the step of receiving an update message of the first service includes:
a step of generating a request message for the updated service code module in response to the update message, and
the step of requesting the additional code module includes:
a step of transmitting the request message for the generated updated service code module to the service providing server together with a request message for the additional code module.

14. The method for providing a service using code streaming according to claim 13, further comprising:
a step of allowing the code execution device to identify that an arithmetic device is added by a hardware extension part of the service providing system; and
a step of executing at least one of the additional code module and the updated service code module in the added arithmetic device as the additional code module and the updated service code module are streamed.

15. A code streaming system, comprising:
a service providing server which stores at least one service code module; and
a service providing system which requests code streaming for a service selected by a user to the service providing server and executes the service code module as the service code module for the selected service is streamed from the service providing server in response to the request,
wherein the service providing system includes:
a camera to which a user's motion image is input;
a code execution device which executes a motion recognition code module to recognize the user's motion image and executes the service code module based on the recognized motion image to generate service data; and
a service output device which executes a UI output code module to output the service data, based on the service data.
